(19) United States
(12) Patent Application Publication
(10) Pub. No.: US 2011/0203978 A1
(43) Pub. Date: Aug. 25, 2011

(54) Water softener with closed-pressure aeration

(76) Inventor: Scott R. Handy, Hagerstown, MD (US)

(21) Appl. No.: 12/659,085

(22) Filed: Feb. 24, 2010

(51) Int. Cl. C02F 5/00; B01D 35/01

(52) U.S. Cl. 210/120

(57) ABSTRACT

A water softener including a water softener tank having an inlet and an outlet. A cation exchange media is positioned within the tank through which water, passing from the inlet to the outlet, is flowed. A valve pedestal is connected to the top of the tank. The valve pedestal includes a dome hole adapter that is screwed into the top of the water softener tank and establishes fluid communication between the inside of the tank and the atmosphere. A downcomer is connected to the dome hole adapter so as to establish an air/water contact within the tank. A variable coupling is connected to the dome hole adapter and extends upwardly therefrom. A pressure release valve is connected to the variable coupling.

### FIELD OF THE INVENTION

The present invention relates generally to apparatus for liquid purification or separation with means to add a treating material.

### BACKGROUND OF THE INVENTION

Hydrogen sulfide (H₂S) found in drinking water supplies is not a health hazard, but it is a common contaminant whose distinctive “rotten egg” smell makes water treatment desirable. Several treatment methods are available.

H₂S is a gas produced by decaying organic matter. It is commonly found in groundwater with little dissolved oxygen. Surface water usually contains little H₂S since it is naturally aerated. Aeration promotes an oxidation reaction that causes H₂S to either escape from water as a gas or precipitate as a solid.

Bacteria living within water distribution systems often produce H₂S. These bacteria consume sulfur-bearing compounds carried in water and excrete H₂S. The bacteria are not dangerous, but the H₂S that they produce yields unpleasant smells and tastes. H₂S may also cause black staining of silverware and plumbing fixtures and can corrode pipes.

Most methods for treating H₂S-contaminated water rely on oxidizing H₂S so as to make a solid precipitate that can be filtered from the water. If H₂S concentrations exceed 6 mg/L, oxidation via chlorination is typical. On the other hand, if H₂S concentrations fall below 6 mg/L, oxidation with manganese greensand is more common.

Chlorination is a widely used method for oxidizing H₂S. Chlorine is usually added to a supply of water in the form of sodium hypochlorite (NaOCl), liquid bleach. Treated water may, unfortunately, have lingering tastes or odors caused by residual chlorine and byproducts of the reaction between NaOCl and H₂S. Therefore, before human consumption, treated water should be passed through an activated carbon filter to remove suspended chlorine and sulfur compounds.

Chlorination systems are available as a pellet-drop unit or a liquid feeder. A pellet-drop unit automatically dispenses a measured amount of NaOCl in solid form into a well casing or into a retention tank during a pumping cycle. A liquid feeder, as the name suggests, delivers NaOCl dissolved in a liquid to an energized well pump.

Manganese greensand carries a coating of manganese oxide (MnO₂). During use, MnO₂ reacts with H₂S to form solid particles that are captured by the greensand itself When the MnO₂ is depleted, the greensand can be regenerated with potassium permanganate (KmnO₄). When greensand is used to treat water with high H₂S concentrations, frequent regeneration is often required.

Catalytic carbon provides an alternative. Essentially, catalytic carbon is activated carbon with a modified surface. Catalytic carbon retains all of the adsorptive properties of activated carbon, but it further exhibits an ability to catalyze chemical reactions. During water treatment, catalytic carbon first adsorbs H₂S and, then, in the presence of dissolved oxygen, converts H₂S into an inert solid.

Aeration is another common treatment for water having dissolved H₂S. During aeration, H₂S is removed by agitating water in contact with air in a special mixing tank. The unwanted H₂S is, after agitating, removed as a gas by venting it with the air from the tank. Aeration is most effective when H₂S concentrations are lower than 2 mg/L. At higher concentrations, aeration may not remove all of the H₂S and supplemental filtration may be necessary.

In a typical aeration system, air is supplied to a mixing tank by a pump. The tank maintains a pocket of air in its the upper third or half. If the tank does not maintain an air pocket, there may insufficient time for dissolved H₂S to escape and foul odors and tastes may return. Fortunately, most household water supplies have low H₂S concentrations; so, small tanks work fine.

Aeration is not always practical for in-home water treatment, especially if H₂S concentrations exceed 10 mg/L. First, large mixing tanks must be set up in a home to allow air and water to mix for long times. Also, objectionable odors must be vented outside the home. Finally, treated water may need to be repressurized for distribution within the home.

### SUMMARY OF THE INVENTION

In light of the problems associated with the removal of H₂S from household water supplies, i.e., the cost of installing single-purpose water treatment apparatus, the need to closely monitor the depletion rate of water treatment chemicals, and the inconvenience of constantly replenishing these chemicals, it is a principal object of my invention to provide a dual-purpose device, one that softens hard water by removing calcium and magnesium ions using cation exchange and that further scrubs the water of H₂S by means of aeration. My water softener is compact in size, easy to install as part of a household water supply system, and requires minimal monitoring. Treated, water is soft and, if it possesses any H₂S, it is at a level where it can be neither smelled nor tasted.

It is an additional object of my invention to provide a water softener of the type described that will strip iron and manganese from a contaminated source.

It is a further object of my invention to provide a water softener of the type described that is easy to clean and service. Should any parts of the water softener wear out or break, they can be easily repaired or replaced.

It is an object of the invention to provide improved parts and arrangements thereof in a water softener with closed-pressure aeration for the purposes described that is lightweight in construction, inexpensive to manufacture, and fully dependable in use.

Briefly, the water softener in accordance with my invention achieves the intended objects by featuring a water softener tank having at least one inlet and at least one outlet. A cation exchange media is positioned within the tank through which water passes from the inlet to the outlet. A valve pedestal is connected to the top of the tank. The valve pedestal includes a dome hole adapter that is screwed into the top of the water softener tank and that establishes fluid communication between the inside of the tank and the atmosphere. A downcomer is connected to the dome hole adapter to establish an air/water contact within the tank above which there is located an air pocket. A variable coupling is connected to the dome hole adapter and extends upwardly therefrom outside the tank. A pressure release valve is connected to the variable coupling.

The foregoing and other objects, features, and advantages of my water softener will become readily apparent upon review of the following detailed description of my water softener as illustrated in the accompanying drawings.

### BRIEF DESCRIPTION OF THE DRAWINGS

My invention more readily understood with reference to the accompanying drawings, in which:

FIG. 1 is a schematic view of a water treatment system incorporating a water softener with closed-pressure aeration in accordance with my invention.

FIG. 2 is a schematic view of the water softener of FIG. 1 showing the direction of flow of water during normal service.

FIG. 3 is a schematic view of my water softener of showing the direction of flow of water during backwashing.

FIG. 4 is a schematic view of my water softener showing the direction of flow of water during brining and slow rinsing.

FIG. 5 is a schematic view of my water softener of showing the direction of flow of water during fast rinsing.

FIG. 6 is a schematic view of my water softener of showing the direction of flow of water during refilling of the brine tank.

FIG. 7 is a partial cross-sectional view of the vent assembly of my water softener.

FIG. 8 is a partial cross-sectional view of an alternate vent assembly for my water softener.

Similar reference characters denote corresponding features consistently throughout the accompanying drawings.

### DETAILED DESCRIPTION OF THE INVENTION

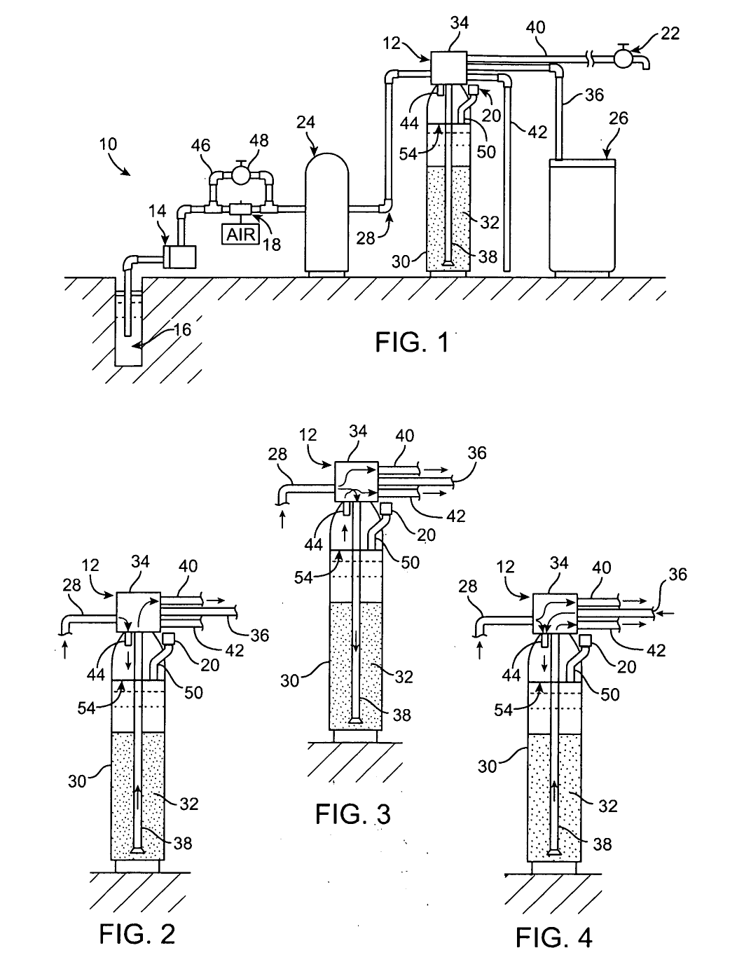

A water supply system 10 incorporating my water softener 12 is shown in FIG. 1. System 10 collects hard water from an H₂S-contaminated source, stores the collected water, treats the collected water, and distributes soft water free of H₂S to a user. Soft water, free of H₂S, is preferred for human consumption and can be odorless and tasteless.

System 10 uses a pump 14 to produce water from a well 16 and deliver it, under pressure, into the water softener 12. A snifter valve 18, connected between the pump 14 and the softener 12, admits air into the passing water stream. Under the influence of gravity, water and air separate in the softener 12. The softener 12 has a pressure release valve 20 that vents air into the atmosphere when a predetermined pressure threshold is reached. The vented air carries away H₂S stripped from the water. Treated water is delivered from the softener 12 to a tap 22 for human consumption. A well tank 24, upstream of the softener 12, stores water and increases the contact time between air and water thereby increasing the efficiency of the system 10 in removing H₂S. A brine tank 26 is also connected to the softener 12 for regeneration purposes.

The well 16 is an orifice in the ground made by drilling, boring, digging, or otherwise, to obtain water. The well 16 can have any depth, diameter, and water production rate. The water produced from the well 16 is, for the purposes of this specification, hard and H₂S-contaminated, but need not be.

The pump 14 may be positioned adjacent to the well 16 or positioned within the well 16 and may be energized by any suitable power source. Pump 14 is shown in FIG. 1 to be located on the ground surface. An electrically powered, submersible pump may be an effective substitute, however.

The pump 14 operates intermittently, in response to water demand by a user. Thus, a sensor (not shown) is connected to well tank 24. The sensor detects a condition where the level of water within the tank 24 falls below a predetermined point and, then, sends an electrical activation signal to the pump 14. In response to the activation signal, the pump 14 is energized and delivers a stream of water from the well 16 to the tank 24. When the water level in the tank 24 exceeds the predetermined level, the sensor ceases to send the activation signal thereby shutting down the pump 14.

For the proper operation of the water supply system 10, the pump 14 must have a sufficient pumping capacity and discharge pressure. It is believed that the system 10 requires a minimum flow of 6 to 8 gpm (23 to 30 L/m) to pull enough air through the snifter valve 18 and into the water supply conduit 28 connecting the pump 14 to the water softener 12. Otherwise, the water produced from the tap 22 may contain residual H₂S.

The water softener 12 has a pressurized softener tank 30 containing a cation exchange media 32. The exchange media 32 is positioned in the bottom of the tank 30 and may be any natural or synthetic material capable of softening water. Naturally occurring zeolites were once commonly used in water softeners because of their excellent ion exchange properties and can be used in the water softener 12. Zeolites have, however, been largely replaced by synthetic organic cation resin ion exchangers of polystyrene divinylbenzene (DVB). The water softener 12 preferably uses DVB in the form of small beads as the exchange media 32.

The water softener 12 has a control valve 34 positioned atop the tank 30 for regulating the flow of water and air to the tank 30, from the tank 30, and through the tank 30. The valve 34 is preferably an Autotrol® Performa™ produced by General Electric Company of Fairfield, Conn. As shown, the valve 34 has three inlets, one being connected to the fresh water supply conduit 28 extending from the pump 14, another being connected to a salt water supply conduit 36 extending from the brine tank 26, and still another being connected to a riser tube 38 partially buried in the exchange media 32 and extending upwardly from the bottom of the tank 30. The valve 34 also has three outlets, one being connected to a household service conduit 40, another being connected to a drain conduit 42, and still another being connected to a spout 44 that opens into the top of the tank 30.

The control valve 34 is electrically powered and is easily programmed. By programming the valve 34, a user may set the course of operation of the water softener 12 (and, to an extent, certain demands to be placed on the pump 14) in advance. The water softener 12 has five operating modes as is illustrated schematically in FIGS. 2-6. The timing and duration of the operating modes are established by a user based on a number of factors including: the initial level of hardness and H₂S contamination of the water, the desired quality of the treated water, the type of exchange media 32 used in the softener 12, and the capacity of softener 12 to treat the water.

The service mode of operation of the water softener 12 is illustrated in FIG. 2. In the service mode, pressurized water from supply conduit 28 is directed by control valve 34 to spout 44. The water pours from the spout 44 into the top of the tank 30 where it is allowed to collect and slowly percolate down through the exchange media 32. After passing through the exchange media 32, the water passes into the open bottom of riser tube 38. From the riser tube 38, the now-treated water is directed by the valve 34 into the household service conduit 40. By selectively opening tap 22 at the terminal end of the conduit 40, a user can draw off soft water, free of calcium and magnesium ions (and H₂S as will be made clear hereinbelow) for use in drinking, laundering, bathing, and dishwashing.

The backwash mode of operation of the water softener 12 is illustrated in FIG. 3. In the backwash mode of operation, the control valve 34 receives pressurized water from the supply conduit 28 and splits the flow, directing some of the water into the top of the riser tube 38 and directing the remainder of the water into the household service conduit 40 to maintain a supply of water, although an imperfect one, to a user. The water in the riser tube 38 exits the open, bottom end thereof and passes upwardly through the exchange media 32 dislodging precipitated oxide particles and other collected sediments. Water carrying suspended particulate matter is now directed by valve 34 from the top of the riser tube 38 into the drain conduit 42 for diversion into a sewer or septic system.

The brine/slow rinse mode of operation of the water softener 12 is illustrated in FIG. 4. In the brine/slow rinse mode of operation, the control valve 34 receives pressurized water from the supply conduit 28. Some of this water is directed by valve 34 into the household service conduit 40 to maintain a supply of water for a user. The remainder of the water received from the conduit 28 is mixed with brine that is permitted to enter the valve 34 from the salt water supply conduit 36. The mixed, salty water is diverted by the valve 34 to the spout 44 from which it pours into tank 30. The salty water percolates down through the exchange media 32, regenerating the exchange media 32, and is collected into the open bottom of the riser tube 38. From the riser tube 38, the salty water is directed by the valve 34 into the drain conduit 42.

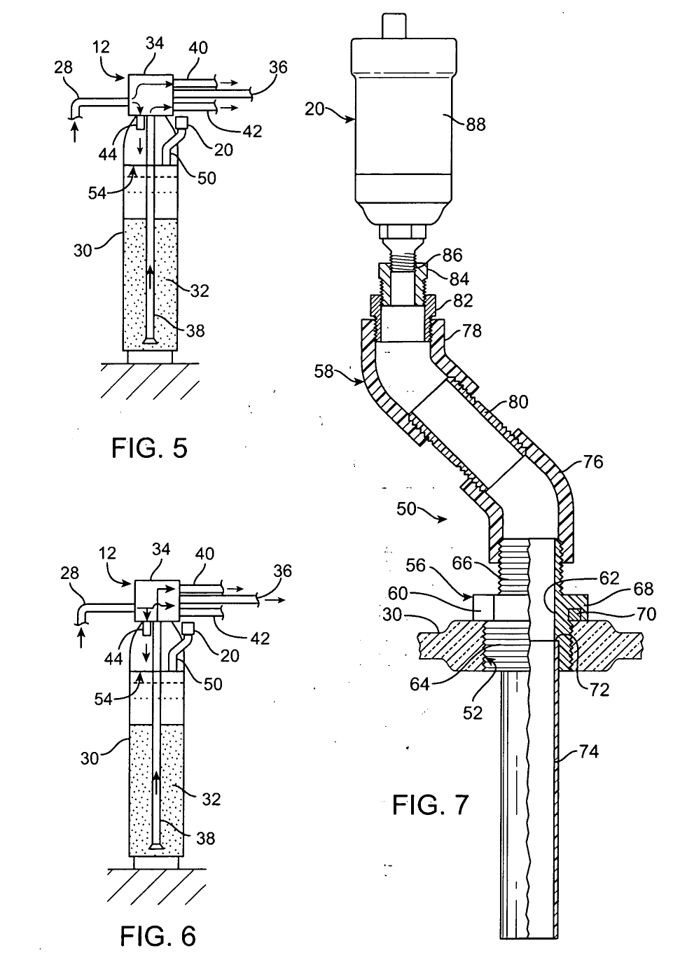

The fast rinse mode of operation of the water softener 12 is illustrated in FIG. 5 and encompasses a final flush of the exchange media 32 to remove any salty water that may remain there. During a fast rinse, the control valve 34 receives pressurized water from the supply conduit 28 and sends some to the household service conduit 40 and some to the spout 44 for delivery into the tank 30. This water percolates through the exchange media 32, mixing with and carrying away any remaining brine. Then, the water passes through the riser tube 38 and is sent by valve 34 into the drain conduit 42.

The refill mode of operation of the water softener 12 is illustrated in FIG. 6. The refill mode is substantially identical to the service mode summarized with respect to FIG. 2. There is one difference, however, and that involves a diversion by the control valve 34 of some water from supply conduit 28 to the salt water supply conduit 36. The water entering the conduit 36 passes into the brine tank 26 to become saturated with salt, usually NaCl, which should be present in the tank 26 because of periodic resupply by the user. The saturated brine is later withdrawn the brine tank 26 when the water softener 12 is operating in the brine/slow rinse mode to regenerate the exchange media 32.

To establish a closed-pressure system, air must be brought into direct contact with water. To this end, the snifter valve 18, sometimes referred to as a “micronizer”) is connected to the water supply conduit 28 downstream of the pump 14. The valve 18 includes a venturi (not shown) through which water 13 streamed in a manner causing a partial vacuum that sucks ambient air into the valve 18 where the air is mixed into the passing water stream. Snifter valves 18 are available from a variety of sources including Mazzei Injector Company of Bakersfield, Calif.

If desired, an air compressor can be substituted for the snifter valve 18 with excellent results. The compressor, however, would likely have more moving parts and would be more likely to break down. The compressor would also require its own power source and would increase the operating cost of system 10. For these reasons, a snifter valve 18 is the preferred means of delivering air to the water softener 12.

Only a portion of the water pressurized by the pump 14 is brought into the snifter valve 18. Since the entire output of the pump 14 is not required to draw sufficient air volumes into the supply conduit 28, a bypass conduit 46 is connected to the supply conduit 28 to divert water around the snifter valve 18. One end of the bypass conduit 46 is connected to the supply conduit 28 upstream of the snifter valve 18 and the other end of the bypass conduit 46 is connected to the supply conduit 28 downstream of the snifter valve 18. A flow valve 48, connected to the bypass conduit 46 between the opposite ends thereof, permits the flow rate of water through the bypass conduit 46 (and, hence, the snifter valve 18) to be controlled with precision.

The air-saturated water in the conduit 28 is delivered into the well tank 24, for the purpose of storage and to limit the on/off cycling of the pump 14, prior to its delivery into the water softener 12. While standing in the tank 24, gravity induces the water separate to a degree from the air injected by the snifter valve 18. Water settles to the bottom of tank 24 and air, containing some oxidized H₂S, fills the top of the tank 24.

Water and air flow from the well tank 24 back into the supply conduit 28 for delivery to the water softener 12. When the control valve 34 is operating the water softener 12 in its service mode, water and air, pressurized by the pump 14 and delivered from the well tank 24, spill from the spout 44 into the tank 30. The water moves under the influence of gravity to the bottom of the tank 30 and air moves to the top of the tank 30. The agitation of the water caused as it falls through the air-filled top of the tank 30, promotes the oxidation of H₂S dissolved within the water and the uptake of H₂S into the air. The water is subsequently drawn through the exchange media 32 and into the riser tube 38 as previously described. When enough air pressure builds up in the tank 30, it triggers the pressure relief valve 20 to open and release H₂S mixed with the excess air. Thus, the softener 12 simultaneously softens water and removes the taste and smell of sulfur.

The pressure release valve 20 is connected by a valve pedestal 50 to the water softener tank 30. The pedestal 50 is a tubular conduit screws into an internally threaded dome hole 52 in sloping top wall of the tank 30 and that supports the valve 20 in an upright position. The pedestal 50 also sets the height of the air/water contact 54 within the tank 30 at a desired location above the exchange media 32. The valve pedestal 50 of FIG. 7 includes a dome hole adapter 56 that is screwed into the dome hole 52 and a variable coupling 58 that is screwed onto the adapter 56. The coupling 58 permits the positioning of the relief valve 20 to be carefully adjusted and finely varied. As will be seen, establishing an upright position for valve 20, away from the conduits 28, 36, 40 and 42 radiating from control valve 34, is important.

The dome hole adapter 56 comprises a polygonal fitting 60 of hexagonal outline whose six sides can be gripped by a wrench (not shown) for rotating the adapter 56 during its installation on softener tank 30. The fitting 56 has a hole 62 extending through its center. An externally threaded sleeve 64 is integrally formed with the fitting 56 and extends downwardly from the bottom of the fitting 56 around the hole 62. Another externally threaded sleeve 66, having both a smaller outer diameter and a smaller inner diameter than that of the sleeve 64, is integrally formed with the fitting 56 and extends upwardly from the top of the fitting 56 around the hole 62. The hole 62 places the interiors of sleeves 64 and 66 in fluid communication with one another.

The adapter 56 joins the softener tank 30 to the variable coupling 58. The sleeve 64 is adapted to be snugly, yet releasably, screwed into the dome hole 52 in the tank 30. The sleeve 66 is adapted to be similarly screwed into the coupling 58. To ensure a watertight fit with the tank 30, the bottom of the fitting 60 is provided with a channel 68 that encircles the sleeve 64. A rubber O-ring 70 is positioned in the channel 68 and seats against the tank 30 to prevent leaks when the adapter 56 is screwed into place.

The inner diameter of the sleeve 66 is the same as the diameter of the hole 62 in the fitting 60. Thus, the fitting 60 and the sleeve 66 together form a smooth internal flow passageway.

The inner diameter of the sleeve 64 is somewhat larger than the diameter of the hole 62. So, a shoulder 72 is formed at the junction between the polygonal fitting 60 and the sleeve 64. The shoulder 72 serves as a stop to the upward movement of a downcomer 74 inserted into the sleeve 64 from below. The downcomer 74 is affixed within the sleeve 64 and the positioning of the open bottom end of the downcomer 74 establishes the height of the air/water contact 54 in the softener tank 30. A long downcomer 74 places the air/water contact 54 low in the tank 30 and a short downcomer 74 sets the air/water contact 54 high in the tank 30.

The downcomer length that a user should select depends on numerous factors. Generally, a lower air/water contact 54 made by a long downcomer 74 provides a greater volume of air in the softener tank 30 to oxidize H₂S and is preferable in dealing with severe H₂S problems. On the other hand, a higher air/water contact 54 afforded by a short downcomer 74, offers more space within the tank 30 to place the exchange media 32 in contact with water. A greater volume of exchange media 32 is preferable in tackling the problem of extremely hard water. Most users will choose to employ a downcomer 74 of medium length.

The coupling 58 is a chain of screwed-together fittings formed of polyvinyl chloride (PVC). The coupling 58 includes a pair of 45° elbows 76, 78 connected together by a nipple 80. The lower 45° elbow 76 is screwed onto the sleeve 66 of the adapter 56. An outside head bushing 82 is screwed into the upper 45° elbow 78. A second, outside head bushing 84 is screwed into the first outside head bushing 82. The fittings 76-84 are in fluid communication with one another and, when connected to the adapter 56, provide a path for air to flow from the interior of softener tank 12 to the atmosphere.

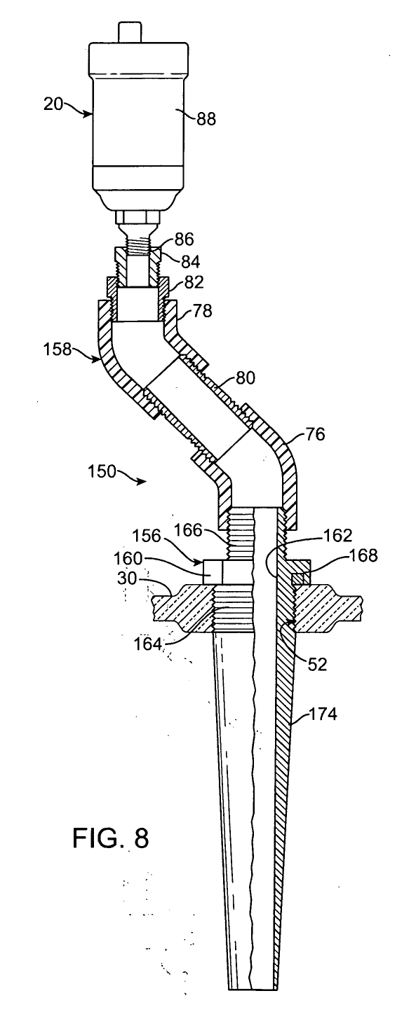

FIG. 8 shows a valve pedestal 150 employing an alternate dome hole adapter 156. The dome hole adapter 156 comprises a polygonal fitting 160 with a hole 162 extending through its center. An externally threaded sleeve 164 is integrally formed with the fitting 156 and extends downwardly from the bottom of the fitting 156 around the hole 162. Another externally threaded sleeve 166, having both a smaller outer diameter than that of the sleeve 164, is integrally formed with the fitting 156 and extends upwardly from the top of the fitting 156 around the hole 162. The hole 162 places the interiors of sleeves 164 and 166 in fluid communication with one another.

The adapter 156 joins the softener tank 30 to a variable coupling 158 that is identical to variable coupling 58. The sleeve 164 is adapted to be snugly, yet releasably, screwed into the dome hole 52 in the tank 30. The sleeve 166 is adapted to be similarly screwed into the coupling 158. To ensure a watertight fit with the tank 30, the bottom of the fitting 160 is provided with a channel 168 that encircles the sleeve 164. A rubber O-ring 170 is positioned in the channel 168 and seats against the tank 30 to prevent leaks when the adapter 156 is screwed into place.

The inner diameters of the sleeves 164 and 166 are the same as the diameter of the hole 162 in the fitting 160. Thus, the fitting 160 and the sleeves 164 and 166 together form a smooth internal flow passageway.

The sleeve 164 is provided with a conical, downward extension, i.e., a downcomer 174. As shown downcomer 174 is integrally formed with the sleeve 164 and has an length of about 8-10 inches. The outer diameter of the downcomer 174 smoothly varies from slightly less than that of sleeve 164 at its top to about % of an inch at its bottom. The inner diameter of the downcomer 174 is the same as that of the sleeve 164 for smooth flow through the adapter 156. Of course, all of the dimensions of the adapter 156 can be changed as a matter of design choice.

The pressure release valve 20 is a Braukmann™ EA122A Automatic Air Vent made by Honeywell, Inc., of Morristown, N.J. The valve 20 has a threaded, tubular stem 86 extending downwardly from the bottom of a valve body 88. The stem 86 is screwed into the outside head bushing 84 and normally conveys air and water from the coupling 58 into the valve body 88. A float-actuated valve seat (not shown) within the valve body 88 selectively opens to release H₂S contaminated air from the tank 30. When the air/water contact 54 is driven below the bottom of downcomer 74 by excess air in the tank 30, the excess air will pass through the valve pedestal 50 and into the valve body 88 in a manner that permits the float-actuated valve seat to open and release the bubble. Of course, other types of valves can be substituted for Honeywell's described above.

The brine tank 26 selectively supplies salt water to the water softener tank 30 for the purpose of regenerating the cation exchange media 32. Periodically, the brine tank 26 must be loaded with a water softener salt. Most commonly used for this purpose is NaCl in crystal or pelletized form. Rock grade salt should be 96.99 percent NaCl. Evaporated salt should be 99+ percent NaCl. Potassium chloride (KCl) can also be used in place of NaCl to minimize the amount of sodium added to both the softened water and the spent regenerant water delivered to the drain conduit—for disposal.

From the foregoing, it should be appreciated that water supply system 10 operates automatically. When the pump 14 is energized to deliver a pressurized stream of water into the supply conduit 28 when the water softener 12 is operating in its service mode, air enters the supply conduit 28 via the snifter valve 18. Oxygen in the air mixes with the pumped water and oxidizes any H₂S dissolved in the water. H₂S, then, dissipates into the air pockets maintained in the well tank 24 and the softener tank 30. Excess air containing H₂S is vented from the softener tank 30 through the pressure release valve 20. Compounds causing water hardness are pulled from the water by the exchange media 32 in the softener tank 30. Soft, H₂S-free water flows into service conduit 40 and is available on demand from tap 22. By operation of the control valve 34, the water softener 12 is backwashed, regenerated, rinsed and refilled.

Once pump 14 pressurizes water from well 16, the supply system 10 does not require additional pumping steps to deliver pure water to a user. After aeration, the water flowing through the system 10 is not exposed to atmospheric contaminants. The oxygenation process is dependent on the contact time of the water within the air-saturator zone. Thus, the system 10 is economical to operate and materially enhances the flavor of the water supplied to a user.

While the water supply system 10 and the water softener 12 have been described with a high degree of particularity, it will be appreciated by those skilled in the water treatment field that modifications can be made to them. For example, it may be desirable to add check valves to the various conduits to prevent siphoning and backflow. Also, the flavor of water produced by the system 10 may be further enhanced by the addition of water filters containing activated carbon or other suitable filter media. Finally, if high concentrations of H₂S are present in the produced water and the water softener 12 is being set up in a building, it may be desirable to install an air blower to vent produced air from the building to reduce odors. Therefore, it is to be understood that the present invention is not limited solely to water softener 12 described above, but encompasses any and all water softeners within the scope of the following claims.

I claim:

1. A water softener, comprising:
a water softener tank having an inlet and an outlet;
a cation exchange media being positioned within said tank through which water, passing from said inlet to said outlet, is flowed;
a valve pedestal being connected to the top of said tank remote from either said inlet or said outlet, said valve pedestal including:
a dome hole adapter being screwed into the top of said water softener tank and establishing fluid communication between the inside of said tank and the atmosphere;
a downcomer being connected to, and extending downwardly from, said dome hole adapter so as to establish an air/water contact at a location below the top of said tank; and,
a variable coupling being connected to, and extending upwardly from, said dome hole adapter; and,
a pressure release valve being connected to said variable coupling.

2. The water softener according to claim 1 wherein said dome hole adapter includes:
a polygonal fitting, being adapted to be grasped by a wrench, with a hole at the center thereof;
a first, externally threaded sleeve being affixed to, and extending downwardly from the bottom of said fitting; and said first sleeve being adapted for threaded connection to said water softener tank;
a second, externally threaded sleeve being affixed to, and extending upwardly from, the top of said fitting wherein said hole in said fitting places said second sleeve in fluid communication with said first sleeve; and said second sleeve being adapted for threaded connection to said variable coupling; and,
a downcomer being inserted into said first sleeve.

3. The water softener according to claim 1 wherein said dome hole adapter includes:
a polygonal fitting, being adapted to be grasped by a wrench, with a hole at the center thereof;
a first, externally threaded sleeve being affixed to, and extending downwardly from the bottom of said fitting; and said first sleeve being adapted for threaded connection to said water softener tank;
a second, externally threaded sleeve being affixed to, and extending upwardly from, the top of said fitting wherein said hole in said fitting places said second sleeve in fluid communication with said first sleeve; and said second sleeve being adapted for threaded connection to said variable coupling; and,
a downcomer being integrally formed with, and extending downwardly from, said first sleeve.
